(19) United States
(12) Patent Application Publication
(10) Pub. No.: US 2016/0025257 A1
(43) Pub. Date: Jan. 28, 2016

(54) Covering for Underground Pipes and Related Methods

(71) Applicant: Michael Derek Birdwell, Jacksonville, TX (US)

(72) Inventor: Michael Derek Birdwell, Jacksonville, TX (US)

(21) Appl. No.: 14/807,815

(22) Filed: Jul. 23, 2015

Related U.S. Application Data
(60) Provisional application No. 62/028,284, filed on Jul. 23, 2014.

(51) Int. Cl. F16L 58/18; F16L 1/06

(52) U.S. Cl. CPC F16L 58/18; F16L 1/06

(57) ABSTRACT

The present invention relates to the protection of underground utilities, such as pipes and cables. The invention provides a protective coating for underground pipes and cables that is flexible, waterproof, durable, and cable of withstanding many different stresses.

### CROSS-REFERENCE TO RELATED APPLICATIONS

This application claims the priority and benefit of U.S. Provisional Patent Application No. 62/028,284 entitled “Covering for Underground Pipes and Related Methods” filed Jul. 23, 2014, which is hereby incorporated by reference in its entirety as if fully set forth herein.

### STATEMENT REGARDING FEDERALLY SPONSORED RESEARCH OR DEVELOPMENT

Not applicable.

### BACKGROUND OF INVENTION

1. Field of the Invention

The disclosed subject matter is in the field underground pipes and cables.

2. Background of the Invention

Many industries utilize underground pipes, cables, and the like. For instance, electric companies, telecommunication companies, plumbing, gas, and oil industries all use some form of an underground network of pipes or cables. Placing electrical or utility cables underground has several advantages. In particular, environments surrounding the underground installations are not encumbered with eyesores or obstacles. Furthermore, underground installations pose less of a threat to wildlife above ground. Finally, laying cables or pipes underground makes the pipes and cables less subject to theft or sabotage.

Despite these advantages, care must be taken when laying underground utilities. Laying a pipe or cable into a ditch and covering it with earth exposes the pipe to forces that can cause breaks, cracks, scratches, or marring. Electrical and telecommunications cables can be damaged from falling rocks during back-filling. Small stones and coarse sand have sharp projections that may be forced against the pipe or cable. The weight of the pipe may stress the rocks that support its weight. Prolonged use can also damage the cables. Damages can occur if vehicular traffic drives over the surfaces over the cables. Laying a pipe underground causes an increase in volume to the soil, and this volume change may change the moisture content of the soil, subjecting steel and metal pipes to corrosion.

There have been several attempts to protect underground pipes and cables from damage from rocks, sand, and the like. Typically, the pipe or cable will be coated or covered with a protective material. For example, U.S. Pat. No. 2,082,175 to Sutherland discloses a shield for pipes. According to Sutherland, a pipe may be coated with any number of different materials for protecting the pipe. In this disclosure, a protective material is cemented to a pipe using an adhesive and reinforcement materials. In some embodiments, plasticizers may be added for additional flexibility. To add a plasticizer, one must heat up the pipe to a temperature of 200° F. and subject the pipe to pressure. These protective methods, while effective, must be part of the manufacturing process and are often not simple enough for an ordinary pipe worker to carry them out at the job site.

While the method disclosed by Sutherland cannot be performed on a job site, U.S. Pat. No. 4,896,997 to Gaylin discloses a method of coating a pipe that can be performed on a job site. Gaylin disclose a method of coating a pipe involving specialized brackets applied to the pipe via a tractor. The method disclosed by Gaylin involves the use of additional and potentially expensive materials and is not a simple enough process that can be done by an ordinary construction worker quickly and easily on a job site.

Both U.S. Pat. No. 5,099,889 to Ratzlaff and U.S. Pat. No. 5,120,381 to Nee disclose a coating for pipes that is easier to apply than those disclosed in Sutherland and Gaylin. Nee and Ratzlaff disclose a covering that features a flexible sheet of porous shock-absorbing material. The covering material initially comes in a long sheet that rolls up for easy transport to a job site. One side of the sheet has an adhesive backing. The protective sheet is applied to a pipe like a giant sticker. While this is much easier to apply than a coating that must be applied during the manufacturing process or via a tractor, there are several problems with an adhesive backing. One problem is that if the application of the protective sheet is not entirely straight or symmetrical, it becomes very difficult to undo the application and reapply the sheet. Furthermore, if the job site is at a location that is particularly windy or dusty, dust or dirt particles may foul the adhesive, causing the adhesive to lose its adhesive properties.

An alternative to protective coverings with adhesive backings is disclosed by U.S. Pat. App. No. 2008/0135119 to Tonooka, which teaches a protective sleeve for cables. The sleeve is wrapped around cables and held in place using hook and loop fasteners (e.g. Velcro®). The protective covering disclosed by Tonooka is designed mostly for packing and shipping use, and not for the final industrial application. A hook and loop fastener lacks the strength for underground use.

Another example of a coating that can be applied on site is, U.S. Pat. No. 5,988,227 to Magoffin, which discloses a protective shield for pipes or cables. The Magoffin covering is a flexible sheet of shock absorbing material. In use, a pipe or cable is placed in the midpoint of the sheet while the material is folded about the pipe. The flexible sheet does not fit snuggly around the pipe and there is excess overlap material. The problem with this is the excess overlap material which is going to waste. Wasted material can increase the cost of a project unnecessarily.

Yet another example of an attempt to protect cables from underground debris is U.S. Pat. No. 4,929,478 to Conaghan, et al. Conaghan teaches a fabric-like ribbon strip that can be wrapped around a cable or a group of cables in a helical manner. A side edge of the strip will overlay the other side edge when applied to the pipe or wiring. After the strip has been applied, the user then heats the strip for setting the strip in place. While wrapping the strip around the cable is a basic simple process (albeit one that could potentially waste excess material if not done efficiently), the additional step of applying heat in order to seal the strip into place is cumbersome and cannot be easily performed on a job site.

In view of the foregoing, a need exists for a method of applying protective coating for underground pipes and cables that is inexpensive and can be performed easily on a job site, and which lacks the drawbacks of an adhesive backing.

### SUMMARY OF THE INVENTION

It is an object of the present invention to provide a protective coating for utilities such as cables and pipes to be laid underground.

It is another object of the present invention to provide a means of securing a protective coating to pipes and cables that is strong enough to keep a sturdy protective coating in place.

It is yet another object of the present invention to provide a method of applying a protective coating to pipes and cables that is simple and can be performed on a job site.

It is yet another object of the present invention to provide a method of applying a protective coating to pipes and cables that does not require expensive equipment.

In one embodiment, disclosed is a covering for underground pipes and cables comprising: a rectangular sheet of a flexible waterproof protective material capable of being rolled; and, wherein the sheet feature markings near the edges of the length of the rectangle which are fixed and equidistance from one another. In another embodiment, disclosed is a method for protecting an underground utility comprising: unrolling a roll of a flexible waterproof covering; placing an underground utility on top of the unrolled covering; wrapping the utility in the covering so that the diameter of the pipe is perpendicular to the length of the covering; securing the covering to the utility via cable ties along the utility.

### BRIEF DESCRIPTION OF THE FIGURES

The manner in which these objectives and other desirable characteristics can be obtained is explained in the following description and attached figures in which:

FIG. 1 is a perspective view of a protective coating that has been laid flat.

FIG. 2 is a perspective view of a pipe that has been coated with the protective coating of FIG. 1.

FIG. 3 is an environmental view of a pipe coated with the protective coating.

FIG. 4 is a perspective view of a cable tie used to secure the protective coating.

### DETAILED DESCRIPTION OF THE INVENTION

Generally disclosed is a covering for underground pipes and cables comprising: a rectangular sheet of a flexible waterproof protective material capable of being rolled; and, wherein the sheet features markings near the edges of the length of the rectangle a fixed and substantially equidistant length apart from one another. The more specific aspects of the disclosed covering are described with reference to the figures.

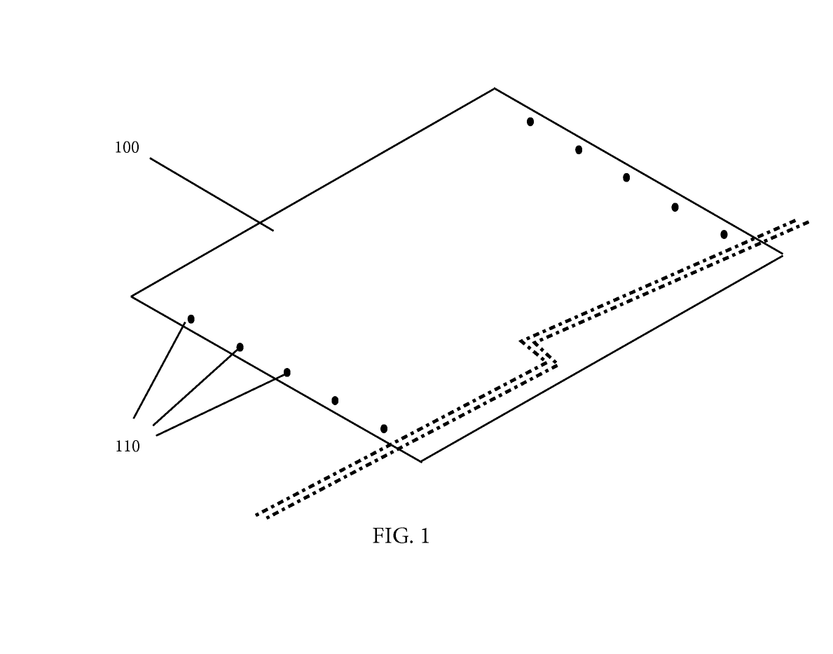

FIG. 1 is a perspective view of the preferred embodiment of a covering 100. The covering 100 is preferably a sheet of pliable PVC, but may also be a different pliable polymer, such as low density polyethylene or high density polyethylene, or porous foam. The covering 100 is typically one-quarter inch or one-half inch thick, although other measurements will work, ranging from 20 millimeters to one-half inch thick. The width of the cover 100 is based on the diameter of the pipe to be covered. In one embodiment the width of the cover 100 may range from eighty inches to one hundred and sixty inches. Preferably, embodiments are based off of the exterior diameter of pipes between sixteen and forty-two inches. Preferably, the covering 100 is between two hundred fifty and five hundred feet long, but may be as small as eight feet or as long as one thousand feet depending on the needs of the project. FIG. 1 shows the covering 100 after it has been unrolled and laid flat. The covering 100 preferably will be made and sold in rolls, so it can easily be transported to and from a job site.

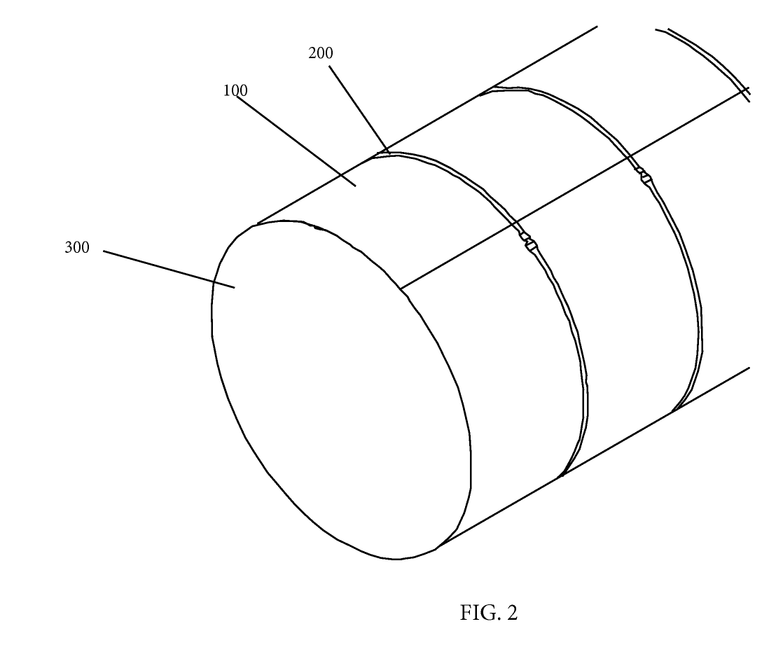

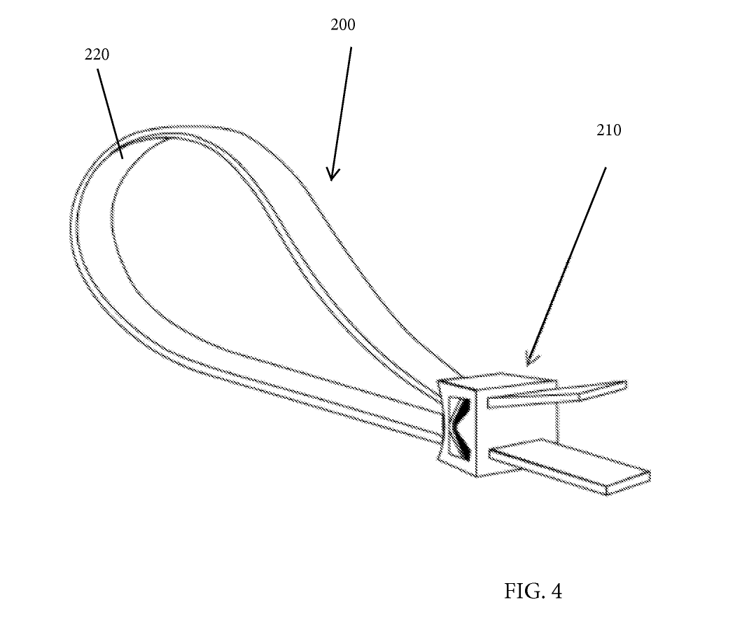

Still referring to FIG. 1, the preferred embodiment of the covering 100 features small holes 110. The holes are preferably three feet apart from one another. The holes 110 assist with the installation process and accommodate cable ties (see FIG. 2, element 200; see also FIG. 4, element 200). The holes 110 may be located on one end or both ends of the covering 100. In some embodiments, instead of holes, the covering 100 may feature guide markings preprinted on the covering. In other embodiments, the covering 100 may feature extruded holes or an adhesive for zip ties to be inserted into the covering 100. The covering 100 may also be clear and transparent to see engineering numbers and locations of welds. Additionally, the covering 100 may feature perforated holes for water to drain and for cathodic protection.

FIG. 2 is a perspective view that shows that covering 100 after it has been applied to a pipe 300. In the preferred embodiment, the covering 100 fully surrounds the diameter of a pipe 300 with little or no overlap. The covering is held in place with the use of cable ties 200. The cable ties 200 are inserted into the holes 110 of the covering 100 and fastened securely.

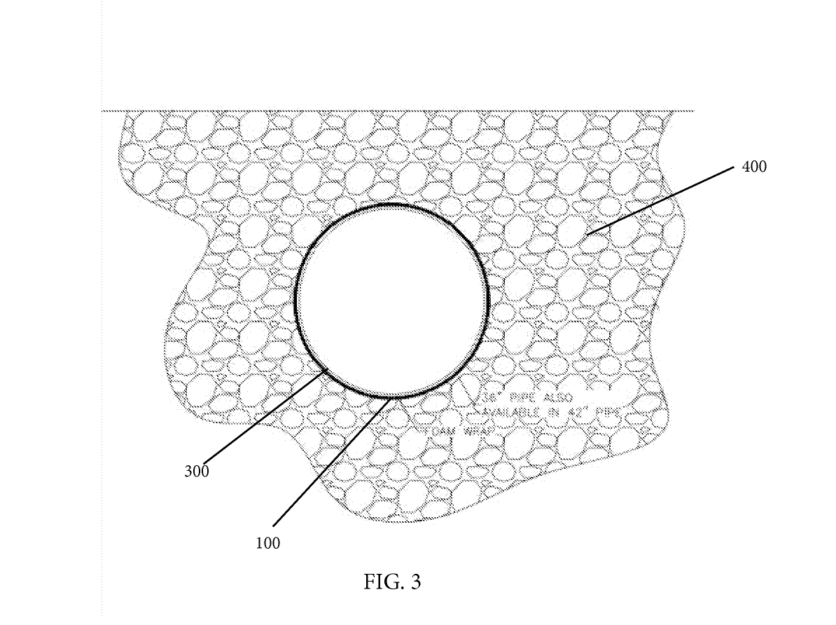

FIG. 3 shows an environmental view of a covered pipe 300 in the ground 400. As depicted in FIG. 3, the ground 400 features hazards such as rough terrain and rocks that can potentially damage the pipe 300.

FIG. 4 is a perspective view of a cable tie 200. The cable tie 200 features a strip 220 and a clasp 210. The strip 220 is preferably made from nylon, but can be made from another polymer. In the preferred embodiment, the strip 220 is 0.036 inches thick and one half inch wide. The strip 200 preferably is made in fifty, one hundred, or two hundred foot rolls and can be cut to a custom length. The cable tie 200 features a clasp 210. The clasp 210 is preferably a one-way double locking head with stainless steel locking teeth that offers four hundred pounds of tensile strength. The cable tie 200 will lock the covering 100 tightly in place and will not stretch or slide.

In an alternate embodiment, the cable ties may be embedded along the covering 100 or preinstalled into the holes 110 of the covering 100 in order to make installation easier.

In order to apply the covering 100 to a pipe 300, a user must first roll out the covering 100 so that it is flat. If needed, the user may have to cut the covering 100 to the desired length. The user then wraps the covering 100 around the diameter of a pipe 300. The user secures the covering 100 to the pipe 300 by encircling the covered pipe 300 with a strip 220 and tightly securing the strip 220 with a clasp 210. In some embodiments, the user will weave the strip 220 through at least one hole 110 on one or both sides of the covering 100. The user will continue to secure the covering 100 onto the pipe 300 by placing cable ties 200 approximately every three feet until the user reaches the end of the pipe 300.

Other features will be understood with reference to the drawings. While various embodiments of the method and apparatus have been described above, it should be understood that they have been presented by way of example only, and not of limitation. Likewise, the various diagrams might depict an example of an architectural or other configuration for the disclosed method and apparatus, which is done to aid in understanding the features and functionality that might be included in the method and apparatus. The disclosed method and apparatus is not restricted to the illustrated example archftectures or configurations, but the desired features might be implemented using a variety of alternative architectures and configurations. Indeed, it will be apparent to one of skill in the art how alternative functional, logical or physical partitioning and configurations might be implemented to implement the desired features of the disclosed method and apparatus. Also, a multitude of different constituent module names other than those depicted herein might be applied to the various partitions. Additionally, with regard to flow diagrams, operational descriptions or method claims, the order in which the steps are presented herein shall not mandate that various embodiments be implemented to perform the recited functionality in the same order unless the context dictates otherwise.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time In the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term module does not imply that the components or functionality described or claimed as part of the module are all configured in a common package. Indeed, any or all of the various components of a module, whether control logic or other components, might be combined in a single package or separately maintained and might further be distributed across multiple locations.

As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

I claim:

1. A covering for underground pipes and cables comprising:
a rectangular sheet of a flexible water resistant protective material capable of being rolled;
wherein said sheet featuring markings near the edges of the length of the rectangle that are substantially and equidistant from one another.

2. A covering according to claim 1 wherein the markings are holes.

3. A covering according to claim 1 wherein the markings are preprinted guide markings.

4. A covering according to claim 1 wherein the markings are three feet apart.

5. A covering according to claim 1 wherein the covering is pliable PVC.

6. A method for protecting an underground utility comprising:
unrolling a roll of a flexible water resistant covering;
placing a utility on top of the unrolled covering;
wrapping the utility in the covering so that the diameter of the pipe is perpendicular to the length of the covering;
securing the covering to the utility via cable ties along the utility.

7. A method of protecting an underground utility according to claim 6, wherein the cable ties are fixed distances from each other.

8. A method of protecting an underground utility according to claim 7, wherein the cable ties are approximately three feet apart.

9. A method of protecting an underground utility according to claim 6, wherein the covering is pliable PVC.

10. A method of protecting an underground utility according to claim 6 further comprising placing the cable tie through at least one hole in the covering.

11. A method of protecting an underground utility according to claim 6, wherein the cable tie features a one way double locking head clasp.
